(19) United States
(12) Patent Application Publication
(10) Pub. No.: US 2016/0348966 A1
(43) Pub. Date: Dec. 1, 2016

(54) Dual Deck Fluid Bed Processor With Separate Air Flows

(71) Applicant: Kason Corporation, Millburn, NJ (US)

(72) Inventors: Hossein Alamzad, New York, NY (US); James Schak, Boonton, NJ (US); William Zhao, Livingston, NJ (US)

(73) Assignee: KASON CORPORATION, Millburn, NJ (US)

(21) Appl. No.: 14/929,178

(22) Filed: Oct. 30, 2015

Related U.S. Application Data
(60) Provisional application No. 62/168,660, filed on May 29, 2015.

(51) Int. Cl. F26B 11/02; F26B 17/12

(52) U.S. Cl. CPC F26B 11/026; F26B 17/12; F26B 11/028

(57) ABSTRACT

A vibrating fluid bed dryer includes a first dryer stage including a first fluid bed air distribution plate mounted therein, and also includes a first air inlet. A a second dryer stage that includes a second fluid bed air distribution plate mounted therein is positioned to receive material from the first dryer stage. The second dryer stage includes a second air inlet. A drive assembly is coupled to vibrate the first dryer stage and the second dryer stage. The first dryer stage may be coupled to a source of cooling air and the second dryer stage may be coupled to a source of warming air, or vice-versa, or both dryer stages may be coupled to a source or warming air or cooling air.

### RELATED APPLICATIONS

This application claims the benefit of provisional application no. 62/168,660 filed on May 29, 2015.

### FIELD OF THE INVENTION

This invention relates to vibratory fluid bed processing equipment.

### BACKGROUND

Fluid bed processors dry, moisturize, heat, or cool bulk solid material by causing the material to vibrate on a screen or perforated surface within a rising column of heated, chilled, or moisturized air. Typical applications include sifting, scalping, classifying, de-dusting and de-lumping of dry bulk solids, or dewatering of solids-laden slurries.

Current designs of circular vibrating fluid bed dryers are generally limited to about a seven-foot diameter in order to achieve higher rates. Current designs of circular vibrating fluid bed dryers require a separate second cooling unit to cool the material after drying. This second, separate unit, requires more headroom and plot space and a second set of drive motors.

### SUMMARY

Embodiments disclosed herein provide a second stage below a first dryer stage and still only use one drive. This eliminates the need for a separate second dryer or cooler, a second set of drive motors, less plot space, less head room, and requires less overall cost. In the past, larger diameter or multiple dryers and/or coolers were used to increase the dryer or cooling capacity. The circular vibrating fluid bed disclosed herein is unique with an internal back mixing capability.

In one aspect, a vibrating fluid bed dryer comprises a first dryer stage including a first fluid bed air distribution plate mounted therein, and includes a first air inlet. A second dryer stage including a second fluid bed air distribution plate mounted therein is positioned to receive material from the first dryer stage. The second dryer stage includes a second air inlet. A drive assembly is coupled to vibrate the first dryer stage and the second dryer stage.

The foregoing apparatus permits a variety of configurations to achieve a variety of material processing purposes. The first dryer stage may be coupled to a source of cooling air, while the second dryer stage is coupled to a source of warming air. Alternatively, the first dryer stage may be coupled to a source of warming air while the second dryer stage is coupled to a source of cooling air. In other configurations, the first dryer stage and the second dryer stage are both coupled to a source of cooling air, or to a source of warming air.

The vibrating fluid bed dryer as set forth above may have a first dryer stage and second dryer stage that are substantially circular in shape and are in a stacked configuration. In other embodiments, the first dryer stage and the second dryer stage may be substantially rectangular in shape, or one stage may be circular and the other rectangular.

In other embodiments, the first dryer stage includes a product outlet with an adjustable weir to control the flow of product through the product outlet and the second dryer stage is positioned beneath the first dryer stage to receive product from the product outlet by way of a product inlet. The second dryer stage may also include a product outlet with an adjustable weir to control the flow of product through the product outlet. The second dryer stage may also be removably mounted.

Additional aspects related to the invention will be set forth in part in the description which follows, and in part will be apparent to those skilled in the art from the description, or may be learned by practice of the invention. Aspects of the invention may be realized and attained by means of the elements and combinations of various elements and aspects particularly pointed out in the following detailed description and the appended claims. It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive techniques. Specifically:

FIG. 1 illustrates an embodiment of a vibratory processor employing the principles of the invention.

FIG. 2 illustrates an embodiment of a multi-spout spacing frame of the processor of FIG. 1.

### DETAILED DESCRIPTION

In the following detailed description, reference will be made to the accompanying drawing(s), which show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

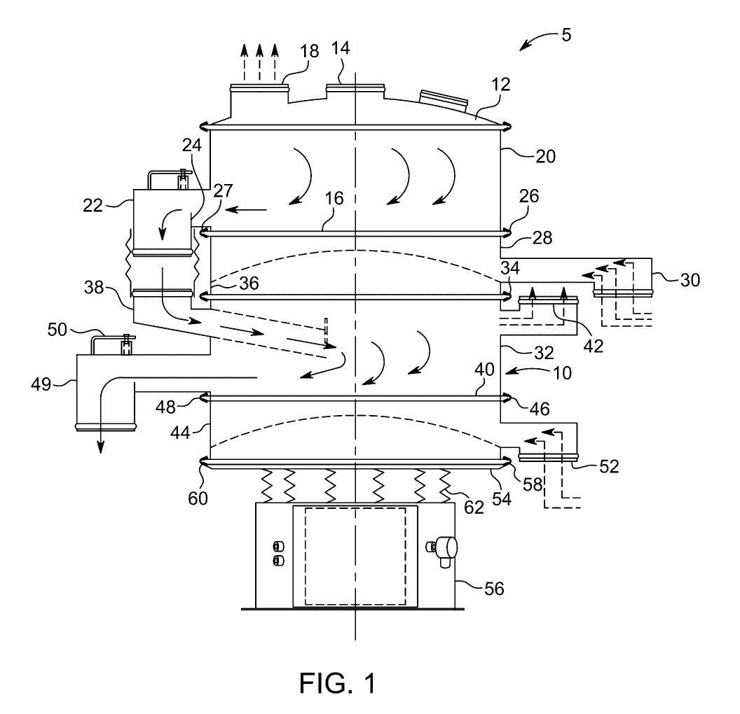

FIG. 1 illustrates an embodiment of a circular vibratory processor 5 employing the principles of the invention. A cylindrical housing comprising a plurality of components described herein, and generally designated 10, is covered by a cover 12. Material is fed into the housing 10 via material inlet port 14 onto the center of fluid bed media (referred to more generically as a fluid bed air distribution plate) 16. The cover 12 has an opening, for air outlet (exhaust) 18. The cover 12 is attached to spacing frame 20 which has a product outlet 22 by which material fed into the housing 10 via inlet port 14 exits. An adjustable weir 24 permits adjustment of the bed depth which controls residence time of the material within the spacing frame 20.

Fluid bed air distribution plate 16 is mounted to the spacing frame and permits air to pass through but not the material. The fluid bed air distribution plate 16 is installed between the spacing frame and the air inlet frame. Clamps and a gasket, seen generally at 26 and 27, are used to clamp the spacing frame 20 to an upper air inlet frame 28. The upper air inlet frame 28 has a spout 30, which permits outside air to enter the housing 10 via the upper air inlet frame 28. The fluid bed air distribution plate 16 may include a variety of different sizes of holes, or include mesh or a screen to permit different rates and types of air flow through the plate.

In the lower portion of the housing 10, multi-spout frame 32 is attached to the upper air inlet frame 28 via clamps seen generally at 34 and 36. A product intake spout 38 on the multi-spout frame 32 accepts material that exits the product outlet 22. The product intake spout 38 has an inclined chute, which directs the material received from the product outlet to lower fluid bed 40. Air exhaust 42 permits outward flow of air. Product outlet 49 on the multi spout frame 32 permits discharge of product from the housing 10. The lower fluid bed 40 is clamped between the multi spout frame 32 and lower air inlet frame 44 with clamps 46, 48. An adjustable weir 50 permits adjustment of the bed depth, which controls residence time of the material within the multi-spout frame 32. Air inlet 52 permits outside air to enter the housing via lower air inlet frame 44. The lower end of air inlet frame 44 is attached to a drive plate 54 of drive assembly 56 by way of a plurality of clamps, two of which are shown at 58 and 60. The drive plate 54 is attached on its lower surface to a plurality of springs 62. This permits the portions above the drive plate 54, in other words, the housing 10 to be suspended on springs 62 that allow the housing 10 to vibrate freely while minimizing power consumption and preventing vibration transmission to the floor. The drive assembly 56 is preferably equipped with one imbalanced-weight gyratory motor that creates multi-plane inertial vibration for the purpose of controlling the flow path of material on fluid bed media surfaces 16 and 40.

FIG. 1 also illustrates operation of the apparatus by showing material flow (solid arrows) and airflow (dotted arrows) through the apparatus 5. Material enters onto the top fluid bed air distribution plate 16 through the opening 14 on the cover 12. The drive system 56 causes vibration, typically in a circular motion, of the apparatus by way of a conventional motor. Moist exhausted air may be passed to a dust collector that separates the dust and moist air. Air entering the air inlets 30 or 52 may be heated or cooled and may be provided via a conventional source to enter the housing 10 and flow from the bottom of the fluid bed air distribution plate 16 or 40 up through the plate and into the spacing frame 20 (in the case of plate 16) or multi-spout frame 32 (in the case of plate 40). After heat exchange that occurs above the fluid bed air distribution plate 16, the product is discharged from the top apparatus through the discharge spout 22 on the spacing frame 20, and the moist exhaust air is emitted through the air outlet 18 on the cover 12.

The upper apparatus and the lower apparatus are clamped together in a manner to allow the product from the upper apparatus to enter the top of the fluid bed media 40 of the lower apparatus. The heating air or cooling air comes from the bottom of the fluid bed air distribution plate 40 though the lower air inlet frame 44. After the heat exchange above the fluid bed air distribution plate 40, the product will discharge from the lower apparatus though the discharge spout 49 on the multi-spout frame 32, and the exhaust air is emitted from the air outlet 42 on the multi-spout frame 32.

The upper and lower portions, which may be fed by different sources of air, permit flexibility in operation of the apparatus. When heating air is introduced to both the top and bottom apparatus, the material will be dried two times, thereby increasing the dryer capacity. When cooling air is introduced to both the top and bottom apparatus, the material will be cooled two times, thereby increasing the cooling capacity. When heating air is introduced to the upper apparatus, and cooling air is introduced to lower apparatus, material will be dried first and then cooled, such as for packaging. When cooling air is introduced to the upper apparatus, and heating air is introduced to the lower apparatus, the material will be cooled first and then heated. This apparatus uses a small footprint, and can do multiple tasks. In contrast, conventional devices will have a large footprint or will use two separate apparatus to do the drying and cooling.

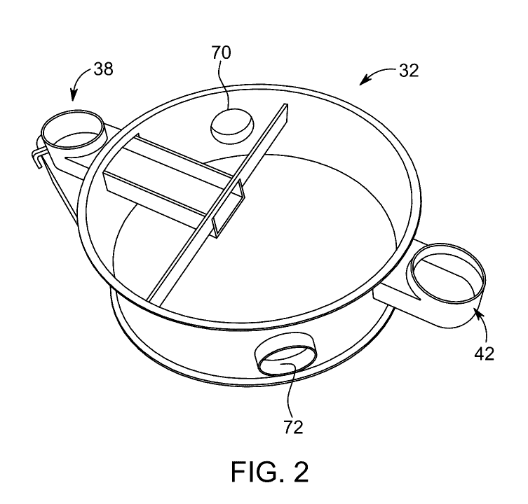

FIG. 2 is a diagram of a preferred embodiment of the multi-spout spacing frame 32 shown in FIG. 1. The product intake spout is shown at 38 with an inclined chute. The air outlet is shown at 42. Also seen in FIG. 2 are inspection ports 70 and 72.

The circular vibrating fluid bed differs from a rectangular vibrating fluid bed as follows:
The circular vibrating fluid bed has an internal backmixing (blending of wet and semi-dry feed materials in the center of the feed zone) capability and as a result can handle a wider range of wet feed material.
The dual deck unit is stacked one on top of the other and takes up less plot space while a rectangular unit is horizontal with the zones side by side
The circular vibrating fluid bed is fed in the middle while the rectangular unit is fed in the front of the unit.
The circular double deck fluid bed apparatus uses one drive assembly with two fluid bed decks clamped up and down together.

The embodiment illustrated in FIGS. 1 and 2 is inherently rigid and does not require heavy steel sidewalls or cross braces to withstand extensive vibration. Moreover, with no internal cross members, fewer seams and corners, such embodiments dramatically reduce cleaning time. Certain embodiments may feature lighter gauge shell and components, with fewer weld seams, and require only one air inlet and outlet resulting in lower material and labor costs—especially when finished to food, dairy, or pharmaceutical standards. Other embodiments may be frame-mounted with casters for low cost shipping, easy installation, and in-plant mobility.

While a circular vibrating fluid bed has the advantageous characteristics as noted above, the upper apparatus or the lower apparatus may also be rectangular in shape and need not be circular. The apparatus can also be used to dedust or screen. A screen could replace the second stage cooler (or dryer).

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

What is claimed is:

1. A vibrating fluid bed dryer comprising:
a first dryer stage including a first fluid bed air distribution plate mounted therein, and including a first air inlet;
a second dryer stage positioned in a substantially stacked configuration with respect to the first dryer stage and including a second fluid bed air distribution plate mounted therein and positioned to receive material from the first dryer stage, and including a second air inlet; and
a drive assembly coupled to vibrate the first dryer stage and the second dryer stage.

2. The vibrating fluid bed dryer of claim 1 wherein the first dryer stage is coupled to a source of cooling air and wherein the second dryer stage is coupled to a source of warming air.

3. The vibrating fluid bed dryer of claim 1 wherein the first dryer stage is coupled to a source of warming air and wherein the second dryer stage is coupled to a source of cooling air.

4. The vibrating fluid bed dryer of claim 1 wherein the first dryer stage and the second dryer stage are both coupled to a source of cooling air.

5. The vibrating fluid bed dryer of claim 1 wherein the first dryer stage and the second dryer stage are both coupled to a source of warming air.

6. The vibrating fluid bed dryer of claim 1 wherein the first dryer stage and the second dryer stage are substantially circular in shape.

7. The vibrating fluid bed dryer of claim 1 wherein the first dryer stage and the second dryer stage are substantially rectangular in shape.

8. The vibrating fluid bed dryer of claim 1 where the first dryer stage includes a product outlet with an adjustable weir to control the flow of product through the product outlet and wherein the second dryer stage is positioned beneath the first dryer stage to receive product from the product outlet by way of a product inlet.

9. The vibrating fluid bed dryer of claim 1 where the first dryer stage includes a product outlet with an adjustable weir to control the flow of product through the product outlet and wherein the second dryer stage is positioned beneath the first dryer stage to receive product from the product outlet by way of a product inlet and wherein the second dryer stage includes a product outlet with an adjustable weir to control the flow of product through the product outlet.

10. The vibrating fluid bed dryer of claim 1 where the second dryer stage is removably mounted.

11. A circular vibratory processor comprising:
an upper stage comprising an upper material inlet port, an upper fluid bed distribution plate, an upper material outlet, an upper exhaust and an upper air inlet;
a lower stage disposed substantially beneath the upper stage comprising a multi-spout frame that is attached to the upper stage and comprising a product intake spout positioned to accept material exiting from the upper material outlet, a lower exhaust, a lower air inlet, and a lower material outlet; and
a motor mounted to the lower stage.

12. The circular vibratory processor of claim 11 wherein the upper stage is coupled to a source of cooling air and wherein the lower stage is coupled to a source of warming air.

13. The circular vibratory processor of claim 11 wherein the upper stage is coupled to a source of warming air and wherein the lower stage is coupled to a source of cooling air.

14. The circular vibratory processor of claim 11 wherein the upper stage and the lower stage are both coupled to a source of cooling air.

15. The circular vibratory processor of claim 11 wherein the upper stage and the lower stage are both coupled to a source of warming air.

16. The circular vibratory processor of claim 11 further comprising an adjustable weir positioned to control flow of material exiting the upper material outlet.

17. The circular vibratory processor of claim 11 further comprising an adjustable weir positioned to control flow of material exiting the lower material outlet.

18. The circular vibratory processor of claim 11 wherein the lower stage is removably attached to the upper stage.
